(19) United States
(12) Patent Application Publication
(10) Pub. No.: US 2010/0320249 A1
(43) Pub. Date: Dec. 23, 2010

(54) METHOD FOR PRODUCING A COMPONENT USING ASYMMETRICAL ENERGY INPUT ALONG THE PARTING OR PREDETERMINED BREAKING LINE

(76) Inventors: Claus Peter Kluge, Roslau (DE); Alexander Dohn, Drosendorf (DE); Michael Hemerle, Marktredwitz (DE)

Correspondence Address: FULBRIGHT & JAWORSKI, LLP, 666 FIFTH AVE, NEW YORK, NY, 10103-3198, US

(21) Appl. No.: 12/528,125

(22) PCT Filed: Feb. 27, 2008
(86) PCT No.: PCT/EP2008/052365

§ 371 Date: Aug. 21, 2009

(30) Foreign Application Priority Data
Feb. 28, 2007 (DE) 10 2007 010 126.2

(51) Int. Cl. B26F 3/06

(52) U.S. Cl. 225/1

(57) ABSTRACT

A method for producing a component, wherein according to the method on at least one surface side of the component at least one parting or predetermined breaking line is produced in that first, in a thermal treatment or procedural step, the parting or predetermined braking line is locally heated by energy input, and then is abruptly cooled by means of a cooling medium such that in the component this temperature fluctuation brings about a targeted crack formation or material weakening along the parting or predetermined breaking line.

The invention relates to a method for producing a component according to the preamble of claim 1.

A method is known from DE 103 27 360 A1, in which at least one metal region is applied to at least one surface side of a ceramic material and after the application of the at least one metal region the metal-ceramic-substrate is heated by energy input along at least one parting or predetermined breaking line in a thermal treatment or procedural step and is then cooled abruptly with a cooling medium in such a way that in the metal-ceramic substrate as a result of this change in temperature a targeted crack formation or material weakening ensues along the parting or predetermined breaking line.

A disadvantage, in this connection, lies in the fact that often no or only insufficient crack formation or material weakening is effected along the parting or predetermined breaking line. Moreover, the spread of the breaking forces under mass-production conditions is insufficient.

The underlying object of the invention is to improve such a method in such a way that a desired crack formation or material weakening occurs under all circumstanced.

This object is achieved in accordance with the invention by means of the features of claim 1.

Owing to the fact that the energy input is effected asymmetrically along the parting or predetermined breaking line at each location, with first a greater energy input and subsequently a smaller energy input being applied at each location of the parting or predetermined breaking line and thus with the energy distribution being adapted to the desired crack formation or material weakening, a desired crack formation or material weakening occurs under all circumstances.

Surprisingly, it has been shown that at each location of the parting or predetermined breaking line that is to be created first a greater energy input is required and as a result a kind of superficial cracking of the surface is effected. The depth of the parting or predetermined breaking line that is to be created can be produced afterwards by means of a weaker energy input.

Components can, for example, be of ceramic material, glass or porcelain. Basically, the components that are to be modified should consist of materials that absorb the chosen types of energy in order to guarantee the effect of the targeted heating.

Ceramic components can be formed so that they are planar or as 3-dimensional bodies.

There can be ceramic components, for example, that are combined with metals or combinations of metals, polymers.

This asymmetrical energy input can be attained by means of various method steps.

The change in the energy input is preferably carried out continuously or in stages. In this way, a substantially better match of the energy feed and the resultant parting or predetermined breaking point characteristic in combination with the materials used is achieved.

In accordance with the invention the energy input is carried out by way of a laser or an infrared source, such as, for example, an infrared lamp.

In a first embodiment, in which the energy input is effected by way of a lens or mirror system or a combination of the same, the energy input is controlled by adjusting the lens or mirror system.

In a second embodiment, the energy input is carried out with at least two lasers or infrared sources so that at least one two-beam method is applied.

In an inventive embodiment, the energy input is controlled by changing the frequency and/or the wavelength of the energy input.

In another inventive embodiment, a mask is placed on the parting or predetermined breaking line that is to be created, and the energy input is controlled by changing or displacing the mask.

In another inventive embodiment, on the component at least one region is coated with a material of the same or different absorptive power as or from the material of the component itself, and the energy input is controlled by means of the absorptive capacity of the coating.

In another inventive embodiment, the energy input is controlled by the same or different variable distances between the parting or predetermined breaking line of the component that is to be created and the energy source.

An inventive development is characterised in that the energy input acts on the substrate from one or a plurality of sides.

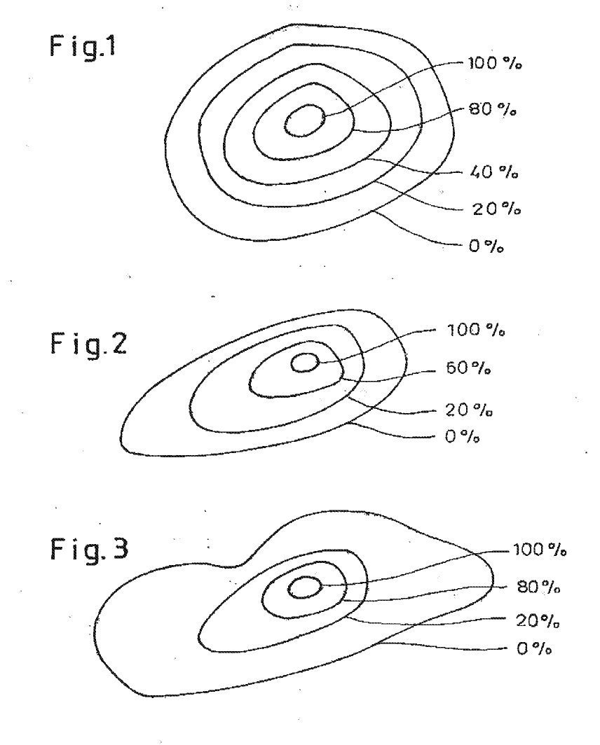

An inventive development is characterised in that the energy input of at least one energy source used is distributed in a symmetrical way or in an asymmetrical way or in a way that is a combination of these ways. The advantage lies in achieving, by way of targeted modification of the geometrical form of the energy input or the focal spot respectively, a desired change in the component to which energy is applied at the location of the energy input. Various energy inputs in the form of topographical contour lines of the same energies (in percent) are shown in FIGS. 1 to 3.

The components can be treated by parting, drilling, perforating, welding, ablation etc.

1-11. (canceled)

12. A method for producing a component, comprising producing at least one parting or predetermined breaking line on at least one surface side of the component so that in the first instance in a thermal treatment or procedural step the parting or predetermined breaking line is heated locally by energy input and subsequently is cooled abruptly by a cooling medium in such a way that in the component as a result of this change in temperature a targeted crack formation or material weakening develops along the parting or predetermined breaking line, wherein the energy input is effected asymmetrically along the parting or predetermined breaking line at each location, with there being applied at each location of the parting and predetermined breaking line at suitably short intervals in time at least two energy inputs that are of the same or different strengths, and with the energy distribution thus being adapted to the desired crack formation or material weakening.

13. A method according to claim 12, wherein the change in the energy input is carried out continuously or in stages.

14. A method according to claim 12, wherein the energy input is carried out by way of a laser or an infrared source.

15. A method according to claim 12, wherein the energy input is effected by way of a lens or mirror system or a combination of the same, and the energy input is controlled by adjusting the lens or mirror system.

16. A method according to claim 12, wherein the energy input is carried out with at least two lasers or infrared sources so that at least one two beam method is applied.

17. A method according to claim 12, wherein the energy input is controlled by changing the frequency and/or the wavelength of the energy input,

18. A method according to claim 12, wherein a mask is placed on the parting or predetermined breaking line that is to be created, and the energy input is controlled by changing or displacing the mask.

19. A method according to claim 12, wherein on the component at least one region is coated with a material of the same or different absorptive power as or from the material of the component itself, and the energy input is controlled by means of the absorptive capacity of the coating.

20. A method according to claim 12, wherein the energy input is controlled by the same or different variable distances between the parting or predetermined breaking line of the component that is to be created and the energy source.

21. A method according to claim 12, wherein the energy input acts on the substrate from one or a plurality of sides.

22. A method according to claim 12, wherein the energy input of at least one energy source used is distributed in a symmetrical way or in an asymmetrical way or in a way that is a combination of these ways.
